(19) United States
(12) Patent Application Publication
(10) Pub. No.: US 2009/0076950 A1
(43) Pub. Date: Mar. 19, 2009

(54) Universal Network-Based Deposit Management Service

(76) Inventors: Ujin Chang, Naperville, IL (US); William Young, San Francisco, CA (US); Gary Williams, Redwood City, CA (US); Peter Hazlehurst, Foster City, CA (US); Matthew Aman, San Mateo, CA (US)

Correspondence Address: CENTRAL COAST PATENT AGENCY, INC, 3 HANGAR WAY SUITE D, WATSONVILLE, CA, 95076, US

(21) Appl. No.: 11/857,123

(22) Filed: Sep. 18, 2007

(51) Int. Cl. G06Q 40/00

(52) U.S. Cl. 705/39; 705/35; 705/40

(57) ABSTRACT

A system for managing electronic deposits remitted to billers includes a first node connected to a network for receiving electronic remittances, a data repository connected to the network for storing account information and account identifier data, a first software routine for looking up account information in the data repository based on received account identifier data, and a second software routine for causing a deposit or credit into an account identified by the account identifier data. Each account subject to electronic deposit is registered with the system, the system issuing an account identifier unique to each account, the identifier used in place of the account number by account owners in remittance instruction to payers.

### CROSS-REFERENCE TO RELATED APPLICATIONS

NA

### BACKGROUND OF THE INVENTION

1. Field of the Invention

The present invention is in the field of electronic payment and deposit systems and services and pertains particularly to methods for facilitating and managing electronic deposits from payer to payee accounts through a common electronic payment interface.

2. Discussion of the State of the Art

The field of electronic billing and payment network services has grown substantially in the last five years and new growth is expected in the industry. Generally speaking electronic payment and billing services are available that enable a consumer and business or a business and another business to exchange payment and billing information and to transact payments electronically eliminating paper records or transactions.

One basic model of electronic bill payment and presentment (EBPP) is that of a billing party, an agent for that billing party; a billed party and an agent for that billed party; a processing entity for the billing party; a processing entity for the billed party; and a network for transmitting remittance and billing information between the processing entities of the model.

In a repetitive transaction model the billing party is termed a biller. The agent for the biller is termed a billing service provider (BSP). A BSP may also be or include a Bill Payment Provider (BPP), an agent for the biller that accepts remittance on behalf of the biller. The payee is generally a customer. The agent for the customer is a customer service provider (CSP). The BSP provides services to the biller like bill hosting, bill consolidation, data parsing, and data formatting for presentment. The CSP provides electronic access for the customer to a bill pay network like one enabled through personal finance management software (PFMS), or some third party service.

The BPP processes payment information for the biller. The CPP processes payment information for the customer and is likely a bank patronized by the customer. The network, typically the Internet network, facilitates the transmission of data between the BPP and CPP. Typical electronic obligations to the consumer are paid by debit account, credit card, or auction clearing house (ACH) payments, which authorize the biller to take the amount from a customer account.

In the art there are numerous variations of the basic EBPP model, for example, there are direct business-to-consumer (B2C) and business-to-business (B2B) models and there are consolidation/aggregation models that may or may not depend on participation from individual billers. A general drawback to the current models being implemented is that they vary by rules, security regimens, and other parameters and may not be easily integrated with one another to a sufficient level of service satisfaction to all parties.

It has occurred to the inventor, who is associated with a consolidator/aggregator for consumers registered to pay bills online, that a model can be conceived that facilitates an automatic universal transaction method for paying bills and receiving bill payments that can incorporate the various EBPP models and the associated transaction networks that exist including more recent credit card remote payment services such as the remote payment presentation service (RPPS) service by Mastercard™ and others.

Therefore, what is clearly needed is a universal network-based deposit management service that relies on current and future transaction and formatting standards and that is secure in that it protects both billing party and consumer data from third-party exploitation and still provides a single bill/pay interface for both billing parties and consumers.

### SUMMARY OF THE INVENTION

According to an embodiment off the present invention, a system is provided for managing electronic deposits remitted to billers. The system includes a first node connected to a network for receiving electronic remittances, a data repository connected to the network for storing account information and account identifier data, a first software routine for looking up account information in the data repository based on received account identifier data, and a second software routine for directing a deposit or credit into an account identified by the account identifier data. In a preferred embodiment, each account subject to electronic deposit is registered with the system, the system issuing an account identifier unique to each account, the identifier used in place of the account number by account owners in remittance instruction to payers.

In one embodiment, the network is the Internet network and the first node is a portal server. In one embodiment, the electronic remittances are sourced from one or more electronic bill pay service networks. In one embodiment, the account information includes an account number and the account identifier data identifies the account number by way of associating the identifier with the account number.

In one embodiment, the account is one of a direct deposit account, a savings account, or an investment account. In a variation of this embodiment, the account identifier is a generated character string containing numbers and letters. In one embodiment, the remittances are sourced from individual payers. In one embodiment, the second software routine is an Auction Clearing House (ACH) electronic credit generating routine.

In one embodiment, the account identifiers are distributed to the account owners personalized Web interfaces at the portal server, the identifiers displayed graphically appearing next to or in association with the biller accounts that have been registered. In one embodiment, deposit notifications are sent to billers as cellular telephone alerts, email alerts, or electronic information page alerts.

According to another aspect of the invention, a method is provided for preparing money-bearing accounts for receiving electronic deposits or credits. The method includes steps of (a) registering the accounts subject to deposits or credits, (b) assigning unique account identifiers for each of those accounts, (c) associating the identifiers to the account numbers in data storage, and disclosing the account identifiers to payers including instruction to include account identifiers with remittance.

In a preferred aspect, in step (a), registration is performed electronically using an electronic data form. In one aspect, in step (b), the account identifiers are character strings including numbers and letters. In a preferred aspect, in step (c), the account identifiers and account numbers are stored together in an encrypted state.

In a preferred aspect, in step (d), the owners of the registered accounts disclose the account identifiers as part of their billing process, the identifiers obfuscating the need to disclose actual account information including account numbers.

According to another aspect of the present invention, a method is provided for directing a deposit of funds or a credit to a money bearing account on behalf of the account owner, the account identified by an account identifier associated with the account number, the account identifier included in an electronic remittance directed to the owner of the account. The method includes the steps (a) receiving the electronic remittance on behalf of the account owner and stripping the account identifier from the remittance information (b) performing a lookup in a data storage repository using the account identifier as a search tuple, (c) receiving a match to the account identifier in storage and retrieving the account number associated with the matching account identifier and (d) generating an electronic credit to the identified account and forwarding the credit to the entity servicing the account.

In one aspect, in step (a) the account identifier is a character string containing numbers and letters. In one aspect, in step (d), the credit generated is an auction clearing house (ACH) credit. In still another aspect, in step (a), the electronic remittance is sent by a bill pay service and is received at a billing service provider. In one aspect, in step (d), an alert is sent to the owner notifying the owner of the issued credit, the alert sent by cellular network or by email.

### BRIEF DESCRIPTION OF THE DRAWING FIGURES

FIG. 1 is an architectural overview of a billing service provider and customer service provider network adapted to facilitate a universal deposit network according to an embodiment of the present invention.

FIG. 2 is a block diagram illustrating layers of software 113 of FIG. 1 according to an embodiment of the present invention.

FIG. 3 is a block diagram illustrating layers of software 112 of FIG. 1 according to an embodiment of the present invention.

FIG. 4 is a process flow chart illustrating steps for acquiring registered accounts for biller services according to an embodiment of the present invention.

FIG. 5 is a process flow chart illustrating steps for practicing deposit based on universal biller account identification according to an embodiment of the present invention.

### DETAILED DESCRIPTION

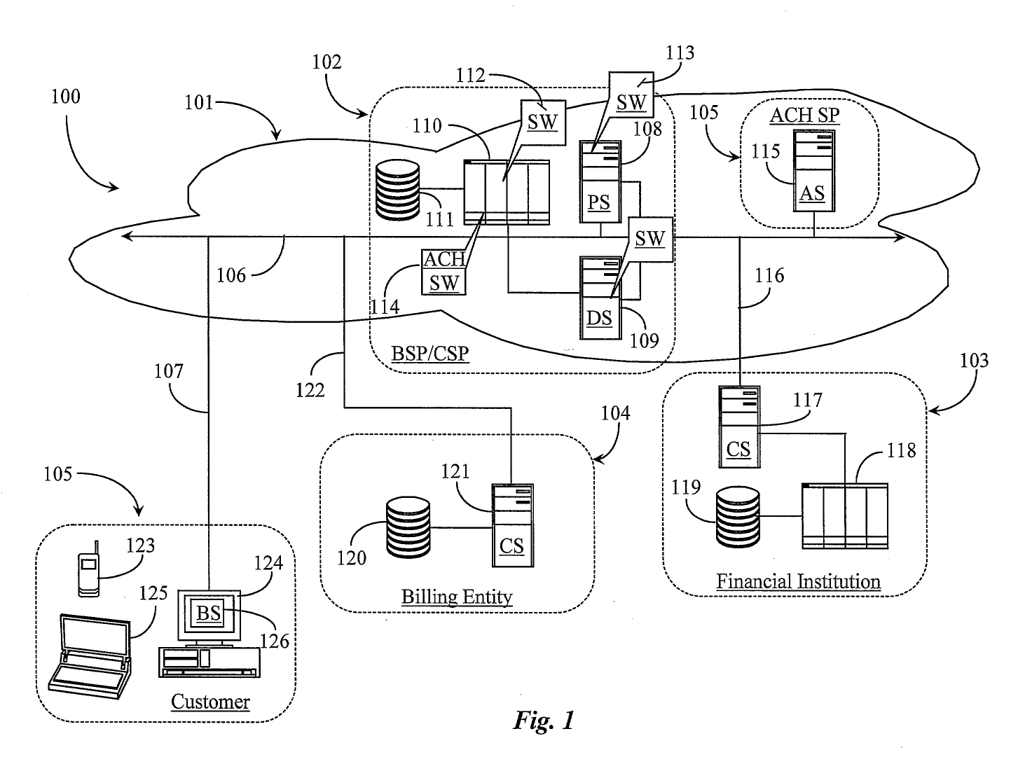

FIG. 1 is an architectural overview 100 of a billing service provider and customer service provider network 101 adapted to facilitate a universal deposit network according to an embodiment of the present invention. Overview 100 includes a billing service provider and customer service provider (BSP/CSP) 102 within the domain of which the present invention may be enabled. Service provider 102 provides financial services to customers including financial management services such as financial portfolio management, net worth reporting, and bill paying services. In this regard, provider 102 is a consolidator/aggregator, meaning that it may consolidate bill obligations for customers and aggregate all of the pertinent data into one secure customer interface.

In an embodiment of the present invention provider 102 is also a billing services provider (BSP) that enables registered (subscribing) billing entities to receive electronic payments into their designated accounts. Service provider 102 offers services over the Internet network represented herein by network cloud 101. Internet 101 is also exemplified by an Internet backbone 106 extending through cloud 101. Backbone 106 represents all of the lines, equipment, and access points that make up the Internet network as a whole. Therefore, there are no geographic limits to the practice of the present invention.

Service provider 102 may also be referred to herein as BSP 102 where the present invention is concerned. BSP 102 includes a portal server (PS) 108 having a network connection to backbone 106. PS 108 is, in this embodiment, a network-connected server that among other things provides access to services for patrons of BSP 102. With proper authentication each patron registered for services with BSP 102 can access services through a personalized, interactive Web-based interface.

BSP 102 includes a main processing server 110. Processing server 110 may be a single, powerful computing system or multiple smaller systems grouped and linked together. Processing server 110 has connection to a distribution server (DS) 109 adapted to distribute or present formatted data to portal server 108 for client access through personalized interfaces. Distribution server 109 is mainly involved in presenting data aggregated by proxy on behalf of clients in formats useable to those clients. PS 108 may access processing entity 110 directly or through DS 109 depending on task definition. DS 108 and main processing entity 110 represent back-end servers and processors and are not accessible to any customers or clients.

A mass data repository 111 is illustrated within the domain of BSP 102 and is connected to the main processing entity 110. Repository 111 may be an internal or external data storage facility of any one of a number of known types such as magnetic or optical storage, RAID array, or other storage facility. Storage facility 111 is logically represented herein as a storage facility that may be read from and written to very quickly and efficiently.

Data repository 111 may hold data about customers or consumers like encrypted password and/or personal identification numbers. Repository 111 may hold account information provided by customers, billing information, and any other data appropriate for facilitating customer interaction and involvement in services provided by BSP/CSP 102. Repository 111 may also hold the same types of authorization information, account information, and other data such as might be required to facilitate service involvement for customers whom are billers wishing to receive electronic payments by using the service of the present invention.

A customer premise 105 is illustrated in this example and represents a customer that is a payer of bills and may be registered with service provider 102 for bill pay services, financial management services or the like. Customer premise 105 includes a variety of computing/communication appliances that may be used to participate in services offered by provider 102 including a desktop computer 124 running an instance of browser software (BS) 126. Not all of the illustrated hardware need be present to practice the invention. Computer 124 has connection to Internet backbone 106 by way of an Internet access line 107. Internet access may be accomplished using known protocols and methods like digital subscriber line (DSL), telephone modem (dial-up), cable modem, or other methods. Other appliances that may be used to access services include a laptop computer 125, and a cellular telephone 123, both of which may be adapted through wired or wireless network connection to access services. Services provided by provider 102 may be accessed through PS 108 as previously described.

It is important to note herein that a customer operating from premise 105 may be one that pays bills using bill pay services and one that wishes to receive electronic payments from others that the customer may be doing some business with. A billing entity 104 is illustrated in this example and represents a potential client of provider 102 that wishes to receive electronic payments. Billing entity 104 may be any type of business entity that has an online presence. In this example, billing entity 104 may have a plurality of patrons, or a customer or consumer base that may access the entity online through a customer server 121 connected to Internet backbone 106 via an Internet access line 122. Access line 122 is typically a high-speed Internet access line. A mass data storage facility 120 is illustrated within the domain of billing entity 104 and, like repository 111, is adapted to store information about customers, products, services, and other data required to facilitate business with the entity and customer relations management between the entity and customers.

Billing entity 104 may be a client of universal deposit management services of the present invention accessible to the business through PS 108 in this example. In one embodiment, customer premise 105 may include one or more patrons of billing entity 104 and billing entity 104 may register with service provider 102 to receive electronic payments from those customers for services rendered. It is important to note herein that billing entity 104 may also be a customer registered with service provider 102 for other financial management services. Service provider 102 may act as an agent for a customer of customer premise 105 and as an agent for entity 104.

A financial institution 103 is illustrated in this example and may be a financial institution patronized by billing entity 104 and by a customer operating from customer premise 105. Financial institution 103 includes a main processing entity 118 and a connected mass data storage repository 119. Processing entity 118 and repository 119 logically represent the processing and service functionality of the institution, which may be, for example, a bank having an online presence. A customer server 117 is illustrated within the domain of institution 103 and represents a customer access point where customers of the institution may access online banking services and other similar services offered by the institution over the network. CS 117 is connected to processing entity 118 and to Internet backbone 106 via an Internet access line 116, which is typically a high-speed line.

An auction clearing house (ACH) service provider (SP) 127 is illustrated in this example and represents a service point on network 101 where ACH services may be accessed. ACH SP 127 includes an ACH server (AS) 115 adapted to process ACH data and transactions according to existing service protocols and according to one embodiment of the present invention where ACH credits are used as part of a universal deposit management process explained in more detail further below.

Referring now to service provider 102, PS 108 includes a software (SW) instance 113 provided thereto and executable thereon. SW 113 is adapted to present a universal deposit management service (UDMS) and to provide an interface to clients that register with the service. UDMS is an electronic deposit management service wherein provider 102 receives payments over the network from patrons of a billing entity on behalf of the billing entity and causes deposit of those funds into one or more designated accounts designated by the billing entity and associated to identification criteria issued by the provider and made available to the entity to pass on to payers doing business with the entity.

Main processing entity 110 comprises a software (SW) instance 112 provided and executable thereon. SW 112 is adapted to manage association of generated universal billing identification numbers (UBIDNs) to actual money-bearing account numbers submitted as designated accounts to receive electronic payments deposited thereto in accordance with an embodiment of the present invention. A UBIDN may be a character string including numbers and letters. In one embodiment, UBIDN may be a unique token. SW 112 manages database storage of encrypted account numbers of billing clients and the associated UBIDNs and also manages database lookup of appropriate account numbers upon system receipt of electronic payment orders bearing at least the name of the payee, the UBIDN, and the correct amount of the billing.

Main processing entity 110 also has an instance of auction clearing house software (ACH SW) 114 provided thereto and executable thereon. ACH SW 114 is adapted, in one embodiment, as a routine that may be called to convert a direct deposit order into an ACH credit that may be sent to a financial institution for application relative to a designated direct deposit (DD) account, savings account, or some other money bearing deposit account.

In practice of the present invention, an entity like billing entity 104, for example, may register with the UDMS of the present invention and may designate one or more accounts to be enabled to receive electronic payments. For discussion purposes, the designated account or accounts may be serviced at financial institution 103. By designating an account it is meant that the billing entity discloses the account number and other required data pertinent to the financial institution servicing the account to service provider 102 aided by SW 113 on PS 108. It is important to note herein that the account numbers are encrypted and not discernable to human operators at any time during the registration process.

After registration is complete, the order is handed off to SW 112 in main processing entity 110. SW 112 generates a UBIDN for each account number disclosed and associates the UBIDN to the appropriate account number to form an authentication pair. The UBIDN numbers created are unique and are useable to represent the account as a token identification of a particular account for which the number was created.

The account number-UBIDN pairs are stored in repository 111 or suitable data storage and may be kept therein in a state of encryption. At the same time the unencrypted UBIDNs are sent to PS 108 where they may be displayed next to the appropriate account icons or descriptions in the billers personalized interface. The biller must perform a secure authentication procedure in order to access the personalized interface created for the new client.

The biller may access the UBIDN or UBIDNs and use them as account numbers for customers who may pay the biller electronically including the number with remittance data. Those UBIDNs may be posted on a Web site accessible to customers, sent to customers in instant messages, simple messaging system (SMS) messages, or via email over any network path available, for example, to a computer, laptop, cellular telephone, Ipod, PDA, etc. Customers, however they receive the UBIDNs, receive them along with the appropriate bill pay information so that the correct remittance amounts, customer account numbers, and other identifying information is available to enable third party application of the deposit or credit.

In one embodiment, payment authorizations from customers are directed to a generic payee name created by service provider 102. This payee name may be registered with existing electronic bill pay services. The UBIDN number identifies the correct deposit account of the biller that the biller has designated as the receiving account. In one embodiment, the customer may have a UBIDN representing the account that the funds are to be withdrawn from in order to make a successful monies transfer. If a customer is known to the system and only has one registered money-bearing account, then by default the provider will consider that account to be the one from which the payment amount is debited. In one embodiment, the customer remittance will include the real account number of the account, which the payment will be retrieved from eventually.

It is possible that a customer is both a biller and a payer in some aspects of the invention. It is also possible that one UBIDN is used to represent a designated account for paying specific debts and for receiving electronic payments from specific entities or customers. Customers of billing entity 104 may send debit authorizations, credit card authorizations, and other forms of electronic payment authorizations using a service provider payee name created by provider 102. The authorization must also include the money recipient name (name of biller) and the UBIDN. The aforementioned are all provided to or made accessible to the customer to append to their electronic remittance.

Service provider 102 may process payment orders received from all of the existing bill-pay and funds transfer networks and service entities as long as the payee name (service provider) and the UBIDN is available to be parsed from the request. If at the very least, the UBIDN is available in a received request, the system aided by SW 112 may perform a lookup in data storage based on the received UBIDN in an attempt to get a match. Upon matching the UBIDN to a data pair stored in the repository, the system may discover the recipient name, the deposit account number where the monies will go, and any other information deemed appropriate or necessary in finishing a task.

In one embodiment, the system aided by SW 114 generates an ACH credit and forwards that credit to ACH SP 127 for processing. The process would in that case continue as an ACH credit authorization containing the deposit account number, (recipient account) and the debited account number (payer account). The UBIDNs may be provided in place of real account numbers so that the transactions are more secure. The service provider may, in one embodiment, actually debit the payer accounts on behalf of the biller and deposit the funds directly into the designated accounts of the biller.

In one embodiment, entity 104 may be an employer and service 102 facilitates a payroll crediting to employee accounts. In this case, each employee would have a designated account registered with the service and a unique UBIDN associated to that account. The employer would then make a payment to the payee name and list the money recipients and the amount of money for each of those recipients. The service provider would perform a lookup to validate all of the UBIDNs and account numbers and would generate credits to all of those accounts for the correct amounts for each employee. The billers account would be debited as each electronic credit is executed at each of the employee designated accounts. The credit and debit authorizations are handled by the electronic banking system that already exists.

A biller may be any person who registers any account that can receive an electronic deposit. A biller may be alerted by cell phone, email, SMS, HTML, or Instant Message to a deposit credit generated by the service provider (BSP 102) at the time the credit is generated and forwarded to the appropriate financial institution managing the account. From the payer perspective, the payee is the biller.

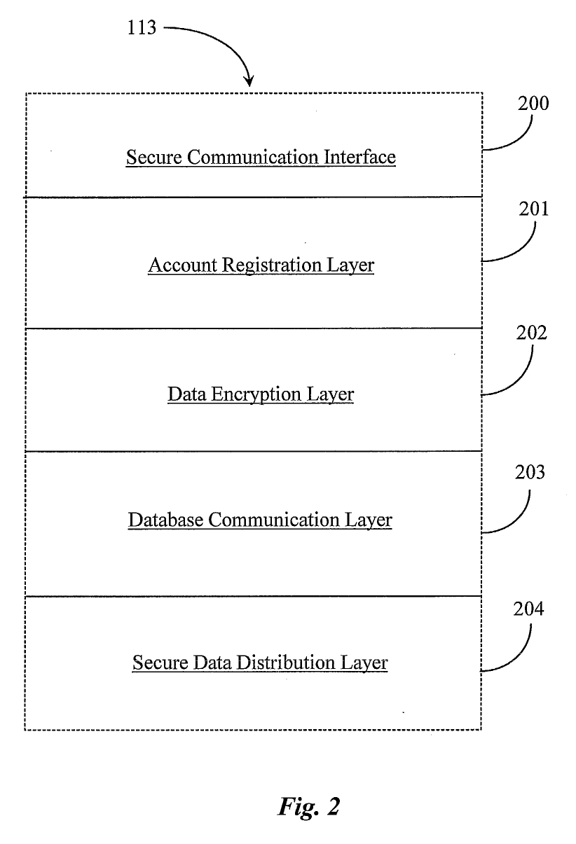

FIG. 2 is a block diagram illustrating layers of software 113 of FIG. 1 according to an embodiment of the present invention. SW 113 includes several component layers for enabling users to register money-bearing accounts for the universal deposit management service of the present invention. SW 113 was illustrated as installed on and executable on portal server 108 of FIG. 1 above. The software may be presented to users as an interactive registration interface including a process for registering accounts with the service.

SW 113 has a secure communication interface layer 200 for establishing a secure communication process with users logged into the server. Secure socket layer (SSL) or other secure transaction Web protocols may be used. In one embodiment, clicking on a registration link or icon re-directs a user to the interface over a secure channel.

SW 113 includes an account registration layer 201. Account registration layer 201 provides the account registration form or forms used to register each money-bearing account for receiving electronic deposits. The actual form may be presented in any Web-based language interface like HTML, SHTML, XML, or other markup versions. The electronic form includes fields where users may input account data including account service entity data, account numbers, and so on. Registration layer 201 may be adapted to register several accounts at one time. Each registered account will receive its own unique UBIDN that can be used by the service to identify the account.

SW 113 has a data encryption layer 202 adapted to encrypt user account information and assigned UBIDNs so that the data is more secure and is not available to human operators. The account numbers and associated UBIDNs may be encrypted as soon as they are entered and may remain in an encrypted state while they are held in storage at the service location. There are many differing types of encryption algorithms that may be used to create an encrypted data pair, essentially, the account number and the UBIDN used for looking up the account and for facilitating deposits into the associated account.

SW 113 includes a database communication layer 203, which is adapted to enable the data input during account registration to be stored in a connected data storage facility. Database access and management may be implemented directly from PS 108 or through a data storage-processing server like processing entity 110 of FIG. 1 for example. Secure data remains in an encrypted state while sitting in data storage ensuring that the data is not usable to unauthorized parties or any human operators. Likewise, data accessed from data storage remains encrypted until it is required to be decrypted by automated machine process. The only human that can see the decrypted data is the owner of the data.

SW 113 is a registration module that employs an interface to accept user data and distributed data destined for display to the owner of the data. For example, after UBIDNs are assigned to user accounts registered with the service, those UBIDNs are distributed back to the owner to use as tokens for payers to utilize in their remittances to the biller so that the monies are deposited in the correct accounts. In this scenario, the payer has no knowledge of any account information of the biller. The BPP/BSP may accept remittances on behalf of the biller and may strip the token ID number to determine which accounts are identified to credit electronically.

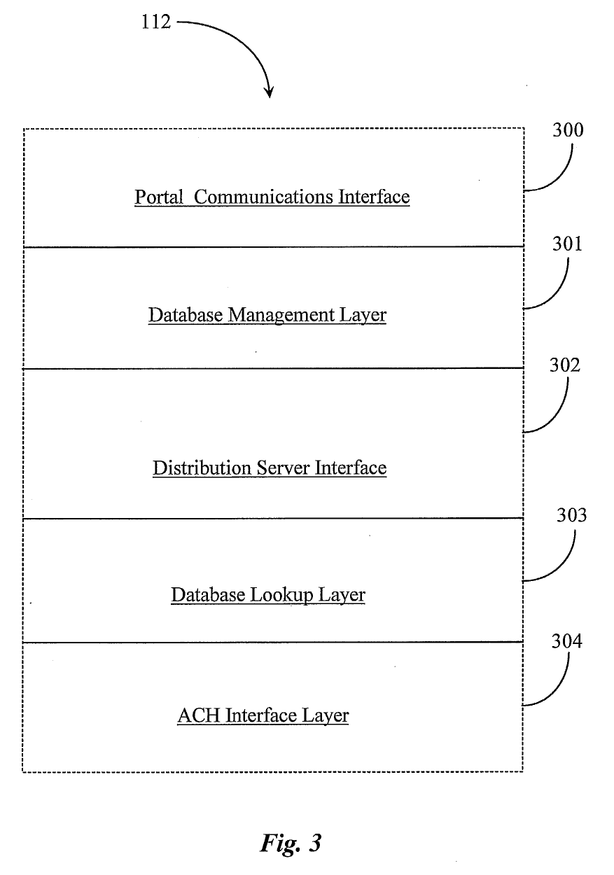

FIG. 3 is a block diagram illustrating layers of software 112 of FIG. 1 according to an embodiment of the present invention. SW 112 includes several component layers for enabling the service provider to maintain data for the biller and to perform the service tasks necessary to fulfill the service of the invention. More particularly, SW 112 enables the service to accept remittances from any standard bill pay network and to provide direct electronic deposits and/or credits to the biller-registered accounts identified to the service by the assigned UBIDNs accompanying the received remittances.

SW 112 includes a portal communications interface 300 adapted to enable the software, which in one example runs on a processing entity like entity 110 of FIG. 1, to communicate with the registration software running on that server. In one embodiment, SW 112 also processes received remittances from standard bill pay networks or from any payer through the portal server on behalf of the biller. In one variation of this embodiment, a biller may have instructions on the billers personalized interface for customers to pay the biller for services, etc. The instructions may accompany a pay-now icon on the billers interface. In this case, users that would pay the biller may make electronic payments through the portal interface of the biller, perhaps in a special section of the interface.

In another embodiment, interface 300 also includes application program interfaces to standard bill pay network services that can also make remittances acting as an agent to customers of the biller. In this case, remittances may be generally received from any payment network directly to processing entity 110 or to a server connected to entity 110 and adapted to receive remittances from virtually any payment service that attaches a UBIDN to the remittance so that the correct biller account may be identified at the service location.

SW 112 includes a database management layer 301 adapted to enable data storage, access, and management of all of the registered billers data including account information and associated UBIDNs. Accounts that are no longer active may be deleted from the data store for any biller that has directed the activity. Likewise, any biller that drops off of the radar such as non-payment for services, closed, or gone out of business can be purged from the system if deemed necessary.

SW 112 has a distribution server interface 302 that is adapted to distribute data from storage to the portal server, among other destinations, for user display in a secure personalized user interface. For example, if a user looses a UBIDN or is not sure which number to use for which account, the user may order a refresh of data from the data store to ensure that the correct token ID numbers are associated with the correct biller accounts. In a preferred embodiment, the biller gives the UBIDN number to payers that would send remittance to the biller. The payers are not aware of any account information of the biller other than the number used as a token to represent the account.

SW 112 includes a database lookup layer 303 adapted to search the database to obtain the correct account information based on received remittance data accompanied by a UBIDN. For every UBIDN received, SW 112 looks up the account associated with the ID and that account then is the account that will receive credit in the form of a direct deposit or some other credit such as an ACH credit. It is important to note herein that the service provider does not maintain actual accounts, but simply generates electronic deposits and/or credits to those accounts on behalf of the biller acting as the biller service provider for registered billers.

In one embodiment, the service functioning as a BSP for billers generates ACH credits and sends them over the ACH network to the biller accounts. In this embodiment, SW 112 includes an ACH interface Layer 304 adapted to enable the processing host to communicate over the network to an ACH server like ACH server 115 of FIG. 1. In one embodiment, the service provider may accept payments from all payment network sources and may generate ACH credits using ACH SW, such as ACH SW 114 of FIG. 1 above. Those credits may then be forwarded to an ACH server for distribution to those various accounts over the ACH secure network. The service provider may provide billers notices or alerts each time an ACH credit is generated and forwarded to the ACH service provider for delivery.

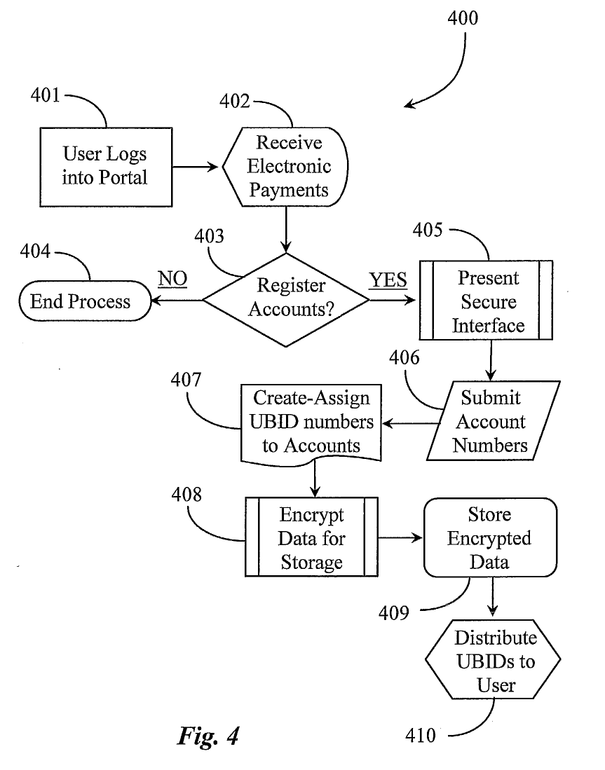

FIG. 4 is a process flow chart 400 illustrating steps 400 for acquiring biller accounts for servicing according to an embodiment of the present invention. In one embodiment of the present invention, the service of the present invention is offered to existing customers of the service provider that are already registered for one or more financial services. In this embodiment, an advertisement or the like may be distributed into personalized customer interfaces and may be visible to the customer during or just after login.

At step 401, a user logs into the portal interface by providing the correct authentication. It may be assumed that at step 402, the user selects a displayed ad or other interactive alert expressing a desire to receive electronic payments. In one embodiment, the service has already assigned unique identification numbers to all of the registered money-bearing accounts of all customers already leveraged for other services. In this case, the account numbers are already known to the service and all the customer need do is activate the account for universal deposit management services (UDMS).

In another embodiment, the advertisement for UDMS may be presented to any new user or existing customer that accesses the service in general whether a login has been performed or not. The opportunity may be communicated to banks, financial institutions, and other entities or avenues in order to solicit new business. If any user has initiated registration by clicking on an icon at step 402, that user is presented with a decision whether or not to register new accounts. The user may already have account information that is known to the system but may wish to add one or more new accounts. Likewise, the user may be completely new to the service provider having no accounts already known to the system.

If in step 402, the user decides not to register any new accounts, the registration process may end at step 404. In this case, if the user already has one or more accounts known to the system, UBIDNs already assigned to those accounts may be distributed to the user. Should the user wish to receive electronic payments via the service of the present invention into any of those accounts in the future the user may simply use the assigned ID number as an account number when invoicing for electronic payment.

In one embodiment, the biller is registered with one or more existing bill pay networks acting on behalf of customers wishing to pay bills electronically. In this case, the biller provides the “token” account number to those services and it is used as the regular account number. All payments associated with an account number assigned by the service provider are routed to the service provider network and are processed on behalf of the registered billers

If at step 403, if a user decides to register one or more new accounts, then in step 405 a secure registration form or interface is presented to that user. The form may ask for account information such as the name of the institution handling the account, the amount deposited in the account, the account number, the branch number of the institution branch where the account was opened, and other similar data if required. At step 406, the user submits one or more account numbers and the other associated account data that may be required by the service.

At step 406, the service aided by SW 113 of FIG. 1 creates and assigns UBID numbers to the accounts listed in the registration form submitted by the user once it has been completed. It is noted herein that step 406 may be repeated many times according to how many accounts a user wants to register. Step 407 is an automated machine-driven process with no human intervention.

At step 408, the system encrypts the data for storage in a secure data repository. In this step, no human operator is involved. The encryption algorithm encrypts both the real account number and the UBIDN associated with that account. The components are stored as an encrypted pair in the data storage facility at step 409.

At step 410, the decrypted UBIDNs are distributed to their owner's personal secure interface appearing right next to the account numbers associated with them. The token Ids may be distributed to owners before the encryption process at step 408 so that a decryption operation does not need to be performed on the customer interface for the user to see the ID numbers and to understand which accounts those numbers are assigned to. The user may elect to use certain numbers as account numbers in billing so that remittances received by the service on behalf of the biller for that billing are deposited into the correct account. At the next billing the biller may use a different UBIDN causing a different account to be credited and so on.

In one embodiment, a biller may send out invoices for services where returning electronic payments are directed into more than one account by percentage basis for example. The biller might apply one UBIDN for 60% of the invoices sent out and a different UBIDN for the rest of the invoices. Therefore, 60% of receipts are deposited into one account while the rest is deposited into the other account. In this way revenue share models may be easily created between business partners, stakeholders, or the like.

In one embodiment, UBIDNs may be assigned to investment accounts like retirement plans, money market funds, and the like. In this embodiment, a certain percentage of revenue from billable operations may be automatically deposited into one or more investment accounts for the biller depending on the UBIDN parameters used in the billing operation. There are many practical ways to earmark funds received based on UBIDN assignments and applications in business. In another example, a company may temporarily donate a certain percentage of proceeds into a charity fund by using a UBIDN relative to the charity fund account as an account number on invoices for any desired percentage of those invoices. Receipt of remittances containing that UBIDN are credited or deposited into the charitable fund account. In this way charities and businesses may cooperate without divulging the account information to each other or to customers.

A steady stream of revenue coming in as periodic payments may be managed before it is received using UBIDNs to determine which of several accounts payments will be credited to.

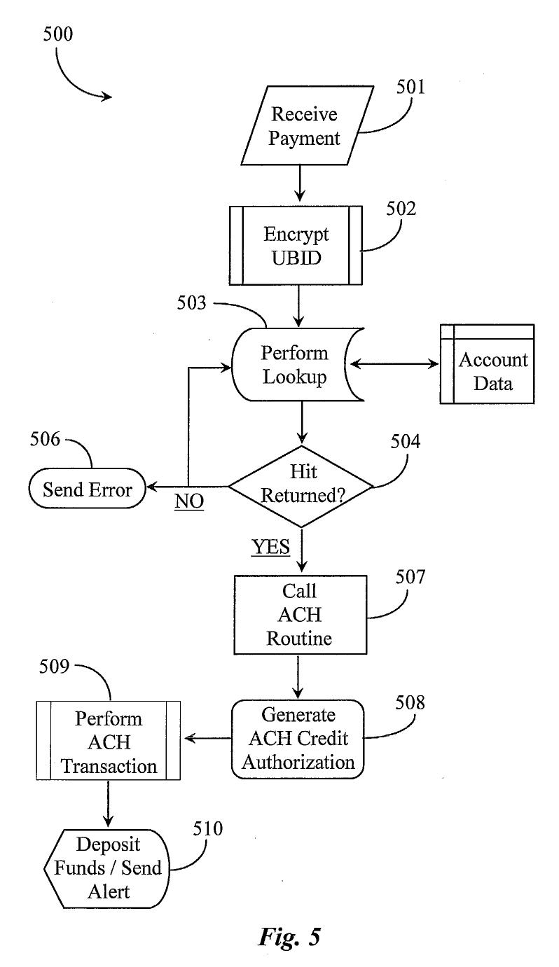

FIG. 5 is a process flow chart illustrating steps 500 for practicing universal deposit management based on universal biller account identification according to an embodiment of the present invention. In act 501, the system receives a payment on behalf of a biller. The payment received may be from any of the bill pay networks known in the art. The payer may or may not be a customer of the service provider. If the payer is a customer, then the payer may be enabled also to be a biller and the UBIDNs assigned to the payer accounts may be used to send payments as well. In this embodiment, no financial information need be disclosed to either party.

At step 502, the system may encrypt the UBIDN associated with the remittance. This step may not be required as it is not specifically necessary to encrypt the token account identification numbers. However, greater security may be desired and the token may be encrypted and used in encrypted form to find the associated account number in data storage.

At step 503, the system performs a lookup in the account data using the encrypted UBIDN as a search tuple. In step 503, there may be more than one UBIDN and instruction to partially credit a certain amount of the remittance into one account and the rest into another account, for example. At step 504, the system determines if there is a hit in the database based on the encrypted UBIDN used to find the associated account. If in step 504, there is no hit, the process may end at step 506 and an error message may be generated and sent to the biller and to the source of the remittance. The source of the remittance may be one of the bill pay systems or an individual customer enabled by software to electronically pay bills online. In one embodiment, the system may attempt the lookup more than one time in which case the process may loop back to step 503.

If an account is found in step 504, then in step 507 the system may call an ACH routine installed locally or provided by an ACH service provider. Finding the account based on UBIDN enables the system to pull up the account information required to enable a credit or a deposit into the account. In the case of generating an ACH credit, this step may be performed by the service provider if authorized in step 508.

In step 508, the service provider may forward the credit to the ACH service network or it may perform the transaction itself if authorized do so. In either case, the ACH transaction is performed in step 509. The ACH transaction authorizes the biller or BSP in this example to debit the payer account and deposit the funds into the biller account identified by the UBIDN. At step 510, the funds are deposited and an alert may be sent to the biller and other parties if appropriate. The alert may simply inform the biller that the funds have been deposited into the account. The biller may rely of the BSP to provide statistics on the frequency of payments received over a specific time period relative to a UBIDN. Information like deposit totals for specific periods and the like may be made available to the biller through their personalized interface.

It will be apparent to one with skill in the art that the universal deposit management system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A system for managing electronic deposits remitted to billers comprising:
a first node connected to a network for receiving electronic remittances;
a data repository connected to the network for storing account information and account identifier data;
a first software routine for looking up account information in the data repository based on received account identifier data; and
a second software routine for directing a deposit or credit into an account identified by the account identifier data;
characterized in that each account subject to electronic deposit is registered with the system, the system issuing an account identifier unique to each account, the identifier used in place of the account number by account owners in remittance instruction to payers.

2. The system of claim 1, wherein the network is the Internet network and the first node is a portal server.

3. The system of claim 1, wherein the electronic remittances are sourced from one or more electronic bill pay service networks.

4. The system of claim 1, wherein the account information includes an account number and the account identifier data identifies the account number by way of associating the identifier with the account number.

5. The system of claim 1, wherein the account is one of a direct deposit account, a savings account, or an investment account.

6. The system of claim 1, wherein the account identifier is a generated character string containing numbers and letters.

7. The system of claim 1, wherein the remittances are sourced from individual payers.

8. The system of claim 1, wherein the second software routine is an Auction Clearing House (ACH) electronic credit generating routine.

9. The system of claim 1, wherein the account identifiers are distributed to the account owners personalized Web interfaces at the portal server, the identifiers displayed graphically appearing next to or in association with the biller accounts that have been registered.

10. The system of claim 1, wherein deposit notifications are sent to billers as cellular telephone alerts, email alerts, or electronic information page alerts.

11. A method for preparing money-bearing accounts for electronic deposits or credits comprising steps of:
(a) registering the accounts subject to electronic deposits or credits;
(b) assigning unique account identifiers for each of those accounts;
(c) associating the identifiers to the account numbers in data storage; and
(d) disclosing the account identifiers to payers including instruction to include account identifiers with remittance.

12. The method of claim 11, wherein in step (a), registration is performed electronically using an electronic data form.

13. The method of claim 11, wherein is step (b), the account identifiers are character strings including numbers and letters.

14. The method of claim 11, wherein in step (c), the account identifiers and account numbers are stored together in an encrypted state.

15. The method of claim 11, wherein in step (d), the owners of the registered accounts disclose the account identifiers as part of their billing process, the identifiers obfuscating the need to disclose actual account information including account numbers.

16. A method for directing a deposit of funds or a credit to a money bearing account on behalf of the account owner, the account identified by an account identifier associated with the account number, the account identifier included in an electronic remittance directed to the owner of the account comprising steps of:
(a) receiving the electronic remittance on behalf of the account owner and stripping the account identifier from the remittance information;
(b) performing a lookup in a data storage repository using the account identifier as a search tuple;
(c) receiving a match to the account identifier in storage and retrieving the account number associated with the matching account identifier; and
(d) generating an electronic credit to the identified account and forwarding the credit to the entity servicing the account.

17. The method of claim 16, wherein in step (a), the account identifier is a character string containing numbers and letters.

18. The method of claim 16, wherein in step (d), the credit generated is an auction clearing house (ACH) credit.

19. The method of claim 16, wherein in step (a), the electronic remittance is sent by a bill pay service and is received at a billing service provider.

20. The method of claim 16, wherein in step (d), an alert is sent to the owner notifying the owner of the issued credit, the alert sent by cellular network or by email.
